(19) United States
(12) Patent Application Publication
(10) Pub. No.: US 2012/0056901 A1
(43) Pub. Date: Mar. 8, 2012

(54) SYSTEM AND METHOD FOR ADAPTIVE CONTENT SUMMARIZATION

(76) Inventors: Yogesh SANKARASUBRAMANIAM, Bangalore (IN); Krishnan Ramanathan, Bangalore (IN); Anbumani Subramanian, Bangalore (IN)

(21) Appl. No.: 12/938,394

(22) Filed: Nov. 3, 2010

(30) Foreign Application Priority Data
Sep. 8, 2010 (IN) 2632/CHE/2010

(51) Int. Cl. G09G 5/00

(52) U.S. Cl. 345/660

(57) ABSTRACT

System and method for adaptive content summarization is disclosed. In one embodiment, a summary size of content is computed based on a usability cost function and an information loss function. Further, a summary of the content is extracted based on the summary size. Furthermore, the extracted summary is displayed on a display device.

### RELATED APPLICATIONS

Benefit is claimed under 35 U.S.C. 119(a)-(d) to Foreign application Serial No. 2632/CHE/2010 entitled “SYSTEM AND METHOD FOR ADAPTIVE CONTENT SUMMARIZATION” by Hewlett-Packard Development Company, L.P., filed on Sep. 8, 2010, which is herein incorporated in its entirety by reference for all purposes.

### BACKGROUND

The rapid progress in computer, data storage and telecommunication has brought a multimedia information era where contents such as web pages, text documents, audio and video data are becoming the information highways of our society. The advent of Internet, World-Wide Web and telecommunications has dramatically changed the manner in which people acquire and disseminate information and knowledge, as computer and telecommunication giants are teaming up with content providers to exploit the huge business potentials on Internet. Television broadcasters, newspaper publishers, entertainment companies, consumer product retailers and service retailers are expanding their presence on the Internet. Electronic devices such as personal computers, PDAs and mobile phones are quickly becoming an information housekeeper for the consumer, and are responsible for accessing and storing content from various sources such as online newspapers and broadcasters.

An inevitable consequence of this evolution is the rise of an overwhelming information glut. Therefore, content summarization can help cope with this information glut. Further, finding a content summary size (i.e., part of relevant information of content from Internet) suitable for a particular consumption device (e.g., mobile phones, netbooks/notebooks, widescreens, television, paper documents, etc.) is a difficult task. Commercial summarizers require a user to specify a summary size each time, which is clearly cumbersome. For example, Microsoft® Word document has a summarization option where the user has to specify a desired size of the summary. The user may not know what a good summary size is suitable for his present consumption mode.

For instance, while a 100 word summary might be appropriate for email consumption, the same may not be suitable on a mobile phone having a small display. Further, if the user specifies a wrong summary size, the user may miss out on valuable information. Therefore, specifying summary size of the content for the present consumption mode is difficult for a user. Furthermore, current summarizers do not consider parameters such as size of the device screen, user interests, current attention span, information loss, etc., when computing the summary. Also, there are no current methods to allow gestural interactions for adapting summaries, for example, to incrementally consume better and better summaries. Moreover, in current methods, a new summary size may result in a completely different set of sentences.

### BRIEF DESCRIPTION OF THE DRAWINGS

Various embodiments are described herein with reference to the drawings, wherein:

FIG. 1 illustrates a flow diagram of a method for adaptive content summarization, according to one embodiment;

FIG. 2 illustrates a graph showing various usability cost functions for different media and classes of devices, according to one embodiment;

FIG. 3 illustrates a block diagram for obtaining concepts using an ontology such as Wikipedia, according to one embodiment;

FIG. 4 is an exemplary diagram illustrating mapping of content components to the concepts obtained in FIG. 3, according to one embodiment;

FIG. 5 is an exemplary diagram illustrating extraction of a summary based on the mapping of FIG. 4, according to one embodiment;

FIGS. 6A-C illustrate exemplary diagrams for adapting the extracted summary using gestural interactions, according to one embodiment;

FIG. 7 illustrates an example of a suitable computing system environment for implementing embodiments of the present subject matter, according to one embodiment;

The drawings described herein are for illustration purposes only and are not intended to limit the scope of the present subject matter in any way.

### DETAILED DESCRIPTION

A system and method for adaptive content summarization is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

The adaptive content summarization method and system described herein provide a solution for adaptive summarization, where initially an optimal summary size is computed and summary corresponding to the optimal summary size is presented to the user depending on the user's profile, consumption mode, display size, attention span, information loss, etc. Then, a user can make gestural interactions to invoke and adapt the summary further, based on the user's interest. This adaptation can be done in real time.

The terms “optimal summary” and “summary” are interchangeably used throughout the document. The term “optimal summary” refers to a summary obtained by minimizing a summary cost function (sum of usability cost function and information loss function). Further, the terms “optimal summary size” and “summary size” are interchangeably used throughout the document. The term “content” refers to text content such as a text document or a webpage. Also, the term “content” refers to multimedia content such as audio content, video content and the like for which a text representation can be derived.

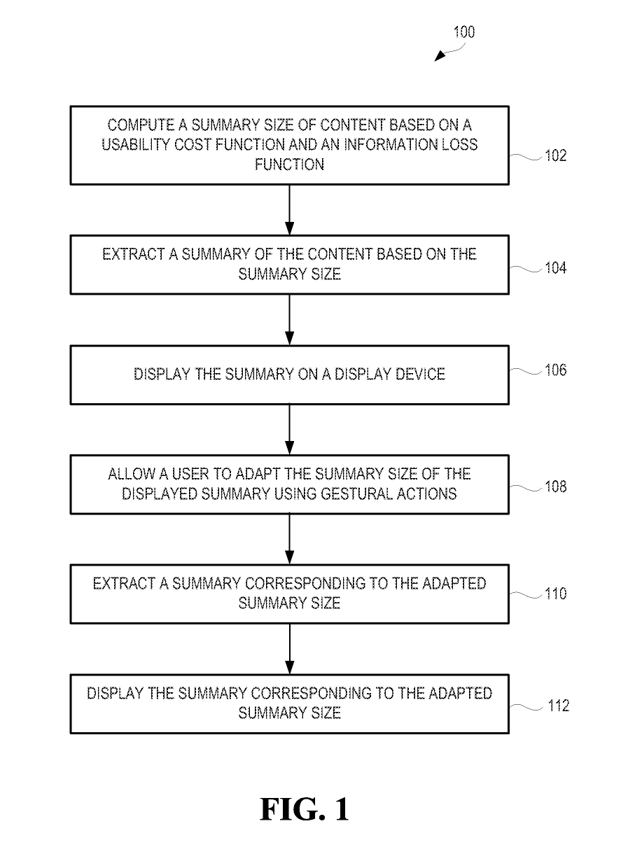

FIG. 1 illustrates a flow diagram 100 of a method for adaptive content summarization, according to one embodiment. At step 102, a summary size of content is computed based on a usability cost function (UCF) and an information loss function (ILF). The summary size corresponds to a percentage of the content for displaying as the summary on a display device. In one embodiment, the UCF is derived based on at least one of consumption medium parameters, user-specific parameters, content-specific parameters and the like.

Further, the consumption medium parameters include but not limited to parameters such as a screen size of the display device and power of the display device. Furthermore, the user-specific parameters include but not limited to parameters such as a user profile, time available to a user, and user attention. In addition, the content-specific parameters refer to text content including but not limited to web pages and text documents. The content-specific parameters also include multimedia content such as video content and audio content for which a text representation can be derived.

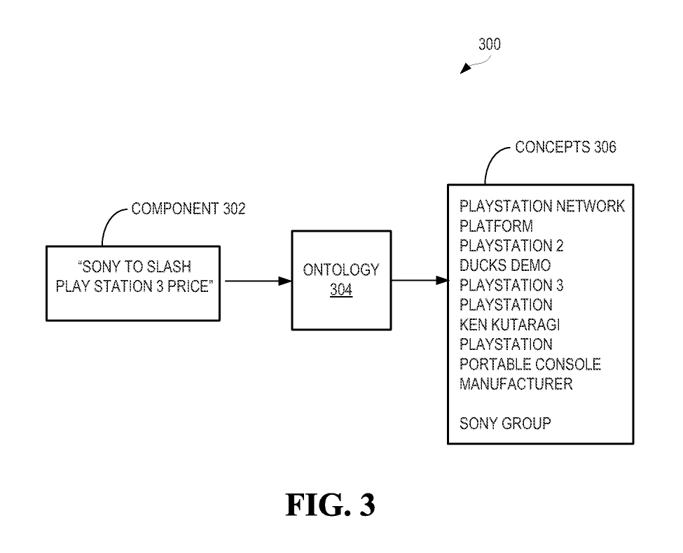

In one exemplary implementation, the UCF can be derived using the following expression:

$$\frac{tanh ( β ( p - α ) ) - tanh ( - βα )}{tanh ( β ( 1 - α ) ) - tanh ( - βα )}$$

Where, p represents a summary size parameter having a range of 0 to 1, α and β are tunable parameters, tan h(β(p-α)) is a scaled and shifted tan h function, and the terms tan h(β(1-α)) and tan h(−βα) are used to normalize usability cost to lie in the range of 0 to 1. The UCF is explained in greater detail in FIG. 3.

In another embodiment, the ILF measures loss of information in consuming the summary when compared with the entire content. In one example embodiment, the information loss function is derived based on parameters such as user-specific parameters and content-specific parameters. The user-specific parameters include but not limited to parameters such as user profile and query-based parameters. Further, the content-specific parameters include but not limited to parameters such as text content (e.g., web pages and text document). Furthermore, the content-specific parameters include but not limited to parameters such as video content and audio content for which a text representation can be derived.

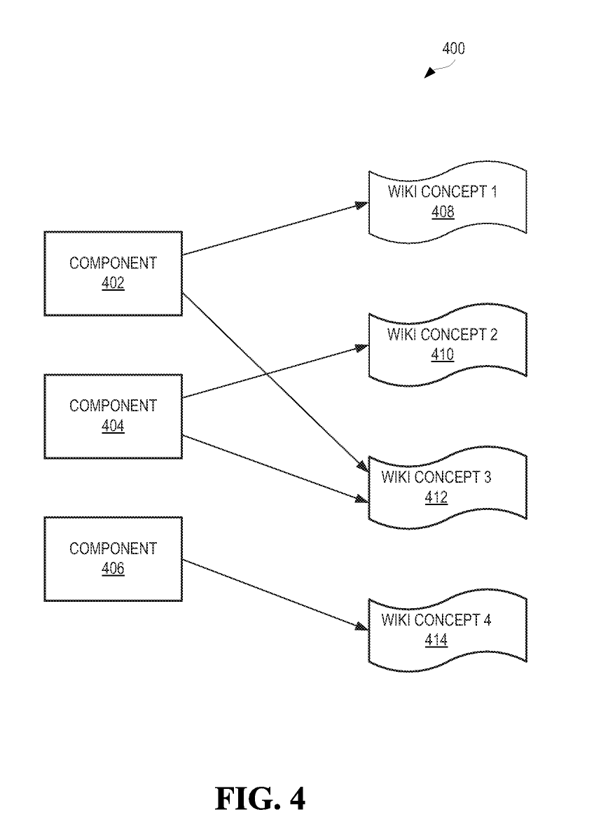

The ILF is computed over ontological concepts or topics. For computing the ILF, the given content (i.e., text, video, and/or audio content) has to be mapped to the concepts. One method of determining such a concept mapping for the text content is described in FIG. 4. Similar mappings can be derived for other media such as the video content and audio content, for instance, using text transcripts, tags and other text descriptions. The intuition behind using the concepts or topics as an information measure is that the concepts conveyed by the content is a measure of the topical information contained therein and this can be used in deciding the summary of the content that is the more relevant and important.

The ILF is defined as a normalized conditional concept entropy (NCCE) of C to a given C(p), which is denoted by NCCE(C/C(p)), where C denotes the concepts associated with the entire content, and C(p) denotes the concepts associated with the summary of the content. The mathematical definitions and details are mentioned in Appendix A. The NCCE is a unique notion of information loss specific to summarization, and is different from other well known definitions of entropy, information, etc.

At step 104, a summary of the content is extracted based on the summary size computed at step 102. Extracting the summary of the content includes mapping each component of the content to one or more concepts obtained using an ontological analysis. In one example embodiment, each component includes at least one of a paragraph, a sentence, a phrase, a clause, and the like. For example, for text content such as a PDF document or a web page, components refer to the sentences in the PDF document or the web page. In another example, for video/audio content, the components could be text descriptions corresponding to the key frames or virtual video segments or any other suitable components. Also, the mapping of each component to the one or more concepts is language independent. In one example embodiment, the ontological analysis includes analysis using ontology such as Wikipedia which is explained in greater detail in FIGS. 3 and 4.

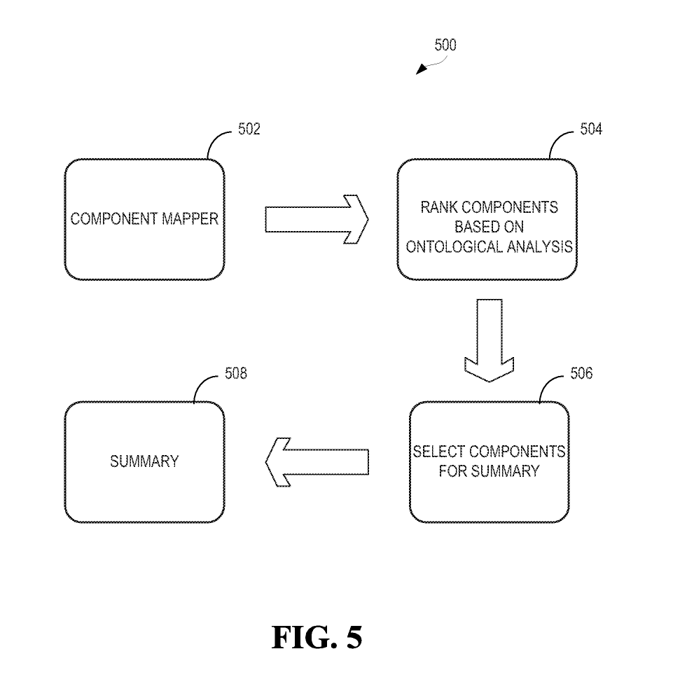

Further, extracting the summary of the content includes ranking each component based on the mapping. In one embodiment, ranking of the components needs to be done only once and can be done off line. The ranking of components is explained in greater detail in FIG. 5.

Furthermore, extracting the summary of the content includes selecting components for the summary based on the ranking of each component and the computed summary size. Finally, the summary of the content is extracted based on the selected components, which is explained in detail in FIG. 5.

At step 106, the extracted summary is displayed on the display device. For example, the display device includes but not limited to a mobile phone, a netbook computer, a notebook computer, a wide screen computer, a slate computer and a television.

In accordance with the above described embodiments with respect to the steps 102-106, usability cost refers to a cost measure associated with usability of the summary. The quality of the summary must not be compromised in view of the usability constraints. Hence, information loss of the summary refers to a natural measure of summary quality which includes the information that the summary conveys, or equivalently, the loss of information upon consuming the summary (instead of consuming the entire content). As mentioned above, the information loss is also factor in user specific parameters such as user profiles, queries, etc. In one example embodiment, the usability cost and the information loss can be specified as a function of the summary size referred to as the UCF and ILF, respectively.

Further, the summary or optimal summary (for the given UCF and ILF) can be computed by minimizing the summary cost function (SCF), which is the sum of the UCF and ILF. In these embodiments, the sum of the UCF and ILF is used since the UCF reflects the property of the consumption medium (like mobile phone, email, paper etc.) and is independent of the summary content, while the ILF depends mainly on the summary content and not the consumption medium. Thus, UCF and ILF can be modeled as independently and additively contributing to the total cost of the SCF. The goal of the optimal summary is to reduce loss of information while presenting the summary.

Therefore, the optimal summary can written as

$$Optimalsummary = {argmin}_{summaries} S C F = {argmin}_{summaries} ( U C F + I L F ) \qquad ( 1 )$$

The optimal summary in equation (1) includes minimization over all possible summaries. Further, an exhaustive search is required to solve equation (1) and is difficult. Therefore, a simple algorithm that is scalable and practical for finding the optimal summary is required.

Let us denote an algorithm for obtaining an optimal summary by “S”. However, the minimization in equation (1) is now complicated by the fact that the ILF now becomes a function of the algorithm S, in addition to the summary size. Therefore, equation (1) can be broke down into the following two steps:

$$\begin{matrix}Optimalsummarysize = {argmin}_{summary - size} S C F = {argmin}_{summary - size} ( U C F + I L F ) & ( 2 ) \\ Optimalsummary = S ( Optimalsummarysize ) & ( 3 )\end{matrix}$$

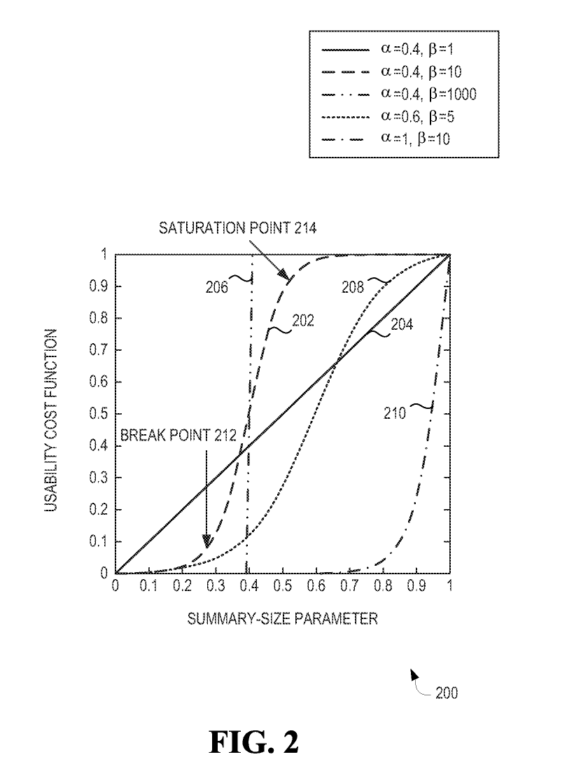

Equation (2) computes the summary size (i.e., the optimal summary size) for the given UCF and ILF, and then the optimal summary is computed in equation (3) as the output of algorithm S for the summary size computed in equation (2). These embodiments are described in detail in FIG. 2.

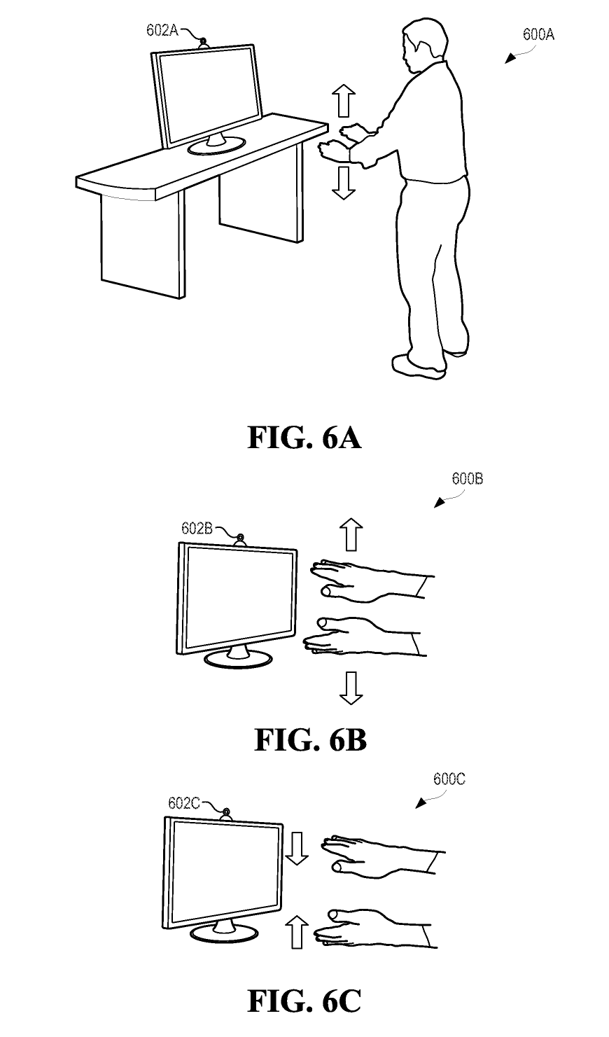

At step 108, the summary size of the displayed summary is adapted by a user using gestural actions. For example, once the summary is presented to the user, the user can choose to control the summary and further adapt the summary using gestural actions. Adapting the summary includes interactively incrementing/decrementing the summary size of the content based on the user's interest. Adapting the summary size of the summary using the gestural actions is explained in greater detail in FIG. 6.

At step 110, a summary corresponding to the adapted summary size is extracted based on the ranking of each component. As mentioned above, ranking of the components needs to be done only once and can be done off line. Hence, the summary corresponding to the adapted summary size is generated by selecting the top ranked components, thereby making the adaptations real time and eliminating the need to run the sentence ranking each time. At step 112, the extracted summary corresponding to the adapted summary size is displayed on the display device.

FIG. 2 illustrates a graph 200 showing various UCFs (202, 204, 206, 208 and 210) for different media and classes of devices, according to one embodiment. Particularly, FIG. 2 illustrates summary size parameter (p) (on X-axis) versus UCF (on Y-axis). The usability cost refers to a cost measure associated with usability of the summary. As explained above, the UCF is derived based on at least one of consumption medium parameters, user-specific parameters and content-specific parameters.

In one example embodiment, the tan h function (as explained in step 102) can adequately model the UCF as follows:

$$U C F = \frac{tanh ( β ( p - α ) ) - tanh ( - βα )}{tanh ( β ( 1 - α ) ) - tanh ( - βα )} \qquad ( 4 )$$

Where

$$tanh ( x ) = \frac{{e}^{x} - {e}^{- x}}{{e}^{x} + {e}^{- x}} ,$$

p is the summary size parameter (0<p<1) which indicates that the summary size is └Np┘, where modulus denotes the greatest integer less than or equal to Np, where N denotes the size of the entire content (for e.g. total number of sentences in a text document), and α and β are tunable parameters. In equation (4), tan h(β(p-β)) is a scaled and shifted tan h function, and the remaining terms are used to normalize the usability cost to lie in the range [0,1].

In one embodiment, the UCF 202 illustrates an example usability cost for a small display on a mobile phone or a smart phone for values of α=0.4 and β=10. The usability cost is zero at p=0 and slowly increases until p reaches a break point 212, after which there is a sharp increase until p reaches a saturation point 214 (near the maximum value of UCF=1 as illustrated in FIG. 2) where the usability cost saturates. Hence, this UCF accurately models the usability of the summary on the mobile phone or the smart phone, for instance, where the display size of the mobile phone or the smart phone dictates the break point 212 and the saturation point 214.

For example, in case of small form factor devices, any summary size beyond the display size incurs an increase in cost penalty, as reflected in the steep rise of the UCF 202 beyond the break point 212. This corresponds to the discomfiture for the user to scroll through a large summary. Beyond the saturation point 214, the summary size is bigger than the display size and is of no utility to the user.

In the UCF mentioned in equation (4), the parameters α and β can be tuned to reflect various media types and consumption mediums. In one embodiment, α can be used to control the position of the break point 214, and β can be tuned to control the rate of cost increase. In an example embodiment, the various UCFs 204, 206, 208, and 210 are shown for different values of parameters α and β.

The UCF 204 with α=0.4 and β=1 models the usability cost for an email summary on a computer screen, where the discomfiture of the reader or user can be modeled as linearly increasing with summary size. Further, the UCF 206 with α=0.4 and β=1000 shows a steep rise and models the usability cost for a strict summary size requirement, as in executive summaries or business document summaries. Furthermore, the UCF 208 with α=0.6 and β=5 models the usability cost for a slightly larger display than a mobile phone, like a netbook, for instance, where the break point lies closer to p=0.4, and also the usability cost rises much slower. In addition, the UCF 210 with α=1 and β=10 models the usability cost for extreme scenarios where the information received from the summary takes prime importance over any usability constraints. Therefore, the UCF 210 is constant (almost zero) for an entire range of reasonable summary sizes. This UCF 210 is relevant with widescreens and important, for example, in analytics, financial statements, business drafts, and the like.

FIG. 3 illustrates a block diagram 300 for obtaining concepts 306 using ontology 304 such as Wikipedia, according to one embodiment. In one embodiment, the concepts 306 are obtained for the components (e.g., a component 302) of the content. In one example embodiment, each component 302 includes at least one of a paragraph, a sentence, a phrase and a clause. As an example, the components include the sentences in a PDF document or a web page for the text content. As another example, for video content or audio content, the components include the text descriptions of key frames, virtual video/audio segments or any other suitable components.

In the example embodiment illustrated in FIG. 3, the concepts 306 are obtained for text content and the component 302 includes but not limited to the sentences (e.g., Sony to slash play station 3 price) in the text content such as a PDF document or a web page. The ontology 304 used for obtaining the concepts 306 (also referred to as document concepts) is the Wikipedia corpus which is indexed using the Lucene engine. As shown in FIG. 3, each component 302 (e.g., the sentence) is input as a query to the Lucene engine and titles (i.e., the concepts 306) of the Wikipedia documents are extracted based on the results associated with the query. This is generally referred as “hits” in Lucene terminology. The concepts 306 (also referred to as Wikipedia concepts) refer to the extracted titles of the Wikipedia documents. Similarly, the concepts 306 can also be obtained for other media like video and audio contents, for instance, using text descriptions, key phrases, tags etc. Once the concepts 306 are obtained, the component to concept mapping is derived as illustrated in FIG. 4.

FIG. 4 is an exemplary diagram 400 illustrating mapping of content components to the document concepts obtained in FIG. 3, according to one embodiment. Particularly, FIG. 4 illustrates a bipartite graph for the text content of components (e.g., components 402, 404, and 406) and mapping of each of the three components in the text content to the document concepts (e.g., Wiki concept 408, 410, 412, and 414).

In the example embodiment illustrated in FIG. 4, the mapping can be captured as a bipartite graph, with one set of nodes (or vertices) representing the components 402, 404, and 406 (e.g., sentences) and the other set of nodes representing the document concepts (e.g., wiki concepts 408, 410, 412, and 414). An edge between a component node and a concept node indicates a mapping between the corresponding document component and document concept. For example, let G denote the bipartite graph so formed (e.g., refer Appendix A for more details). As shown in FIG. 4, the number of components N (i.e., sentences) is 3 and the number of concepts M is 4.

The connection matrix G is used to derive the summary of size └Np┘ sentences, such that the information loss is small. The algorithm works on the principle that high frequency concepts are more important than low-frequency concepts. Once the content components 402, 404, and 406 are mapped to the document concepts 408, 410, 412, and 414, the summary is extracted based on the summary size as explained in FIG. 5.

FIG. 5 is an exemplary diagram 500 illustrating extraction of a summary based on the mapping of FIG. 4, according to one embodiment. At step 502, the component mapper maps the content components to the document concepts as explained in FIG. 4. At step 504, each component is ranked based on the mapping. In these embodiments, the high-frequency concepts are more important than low-frequency concepts.

For example, a score xₙ is associated with each component Sₙ, the score xₙ is an indicative of a confidence measure, i.e., it acts as a measure of the relative chance that the component Sₙ belongs to the summary. We iteratively update the component scores xₙ using the structure of the bipartite graph (e.g., captured in G).

The pseudocode for the summarization algorithm is given below (e.g., with comments on the right hand side). The number of iterations T can either be fixed or arrived at using a suitable stopping criterion. If the scores associated with each component are all initialized to one, then an iterative update (e.g., using an accumulate broadcast function) causes the component scores to converge to a steady value within a few iterations.

Algorithm S

| | | |
|---|---|---|
| Input | | |
| D | | given document |
| p | | summary size parameter |
| Initialize | | |
| xₙ⁰ = 1, | n = 1, 2, . . . , N | initialize component scores |
| for t = 1 to T | | |
| ${y}_{m}^{t + 1} = {\sum }_{n ∈ {N}_{m}} {x}_{n}^{t} ,$ | m = 1, 2, . . . , M | accumulate step |
| ${x}_{n}^{t + 1} = {\sum }_{n ∈ {N}_{m}} {y}_{m}^{t} ,$ | n = 1, 2, . . . , N | broadcast step |
| ${x}_{n}^{t + 1} = N \frac{{x}_{n}^{t + 1}}{{\sum }_{j = 1}^{N} {x}_{j}^{t + 1}}$ | | normalization |
| end | | |

| | |
|---|---|
| r = arg(descend(x^{t})) | sort component scores in descending order, |
| | and only retain the sorted indices. |

Let S denote the vector of components corresponding to the indices of r. For example, if r=(4 7 2), then S=(S₄ S₇ S₂), which represent the fourth, seventh and second components, respectively, in D.

Output: The document summary S(p;D), formed by selecting the first └Np┘ components in S, and presenting them in the same order as they appear in D.

The optimal summary size can be computed using the algorithm S with equations (2) and (3) and then the summary can be extracted and presented as the output of algorithm S for this optimal summary size or the user specified size (in the case of gestural adaptation as illustrated in FIGS. 6A-C). Once the components are ranked using the algorithm S, adaptive summaries of different sizes can be generated by selecting the top-ranked components at step 506. In these embodiments, the ranking can be done only once and there is no need to run the component ranking each time, which makes the adaptations real-time. Further, in step 508, the selected components are displayed as summary on the display device.

FIGS. 6A-C illustrate exemplary diagrams for adapting the extracted summary using gestural interactions, according to one embodiment. Particularly, FIG. 6A illustrates an exemplary diagram 600A for controlling the extracted summary using gestural interactions from a suitable distance. Further, FIG. 6B illustrates an exemplary diagram 600B for expanding the displayed summary using gestural interactions. Furthermore, FIG. 6C illustrates an exemplary diagram 600C for compressing the displayed summary using gestural interactions. In one embodiment, a user is allowed to adapt the summary size of the displayed summary using gestural actions. Further, a summary corresponding to the adapted summary size is extracted based on the ranking of each component.

For example, if the summary size is computed as 20 percent of the content having 1000 components, then the summary corresponding to the summary size of 20 percent (i.e., 200 components) is extracted and displayed on the display device based on the ranking of the components as explained above. Further, if the user chooses to adapt, for example, increment the summary size of the content to 40 percent of the content, then the summary corresponding to 40 percent (i.e., 400 components) of the content is extracted based on the ranking of the components, for example, by selecting the top-ranked components of the content. Hence, there is no need to run the ranking of the components while adapting the summary size and hence the adaptation can be run in real time. Further, the extracted summary corresponding to the adapted summary size is displayed on the display device.

In accordance with above described embodiments with respect to FIGS. 6A-C, Once the optimal summary is presented to the user, the user can choose to control and further adapt the summary using gestural actions. FIGS. 6A-C illustrate invoking/adapting the summary size using gestures by the user. In one exemplary implementation, the system includes a camera (e.g., 602A, 602B, and 602C) for reading/interpreting/analyzing the gestural actions of the user.

For example, the action of two hands (or the action of thumb finger with other fingers in one hand) moving apart can be interpreted as a command to expand the displayed summary (as illustrated in FIG. 6B), while the action of two hands (or the action of thumb finger with other fingers in one hand) moving closer can be interpreted as a command to display a shorter summary (as illustrated in FIG. 6C). For example, the display device includes a gesture recognition system using the camera which could be used for summary adaptation. In another example, other suitable gestures like single-handed pinching, expand etc. could also used.

Thus, the user can interactively increment/decrement content depending upon interest in the given topic, thereby reducing cognitive load and simplifying content consumption for the user.

Alternatively, the user can even use simple opening gestures on touch/hover with a single hand, or configure any other suitable gesture for adapting the summary. The summary adaptation may also be done using keyboard, mouse, or touch, and the like devices, for instance in case of smart phones.

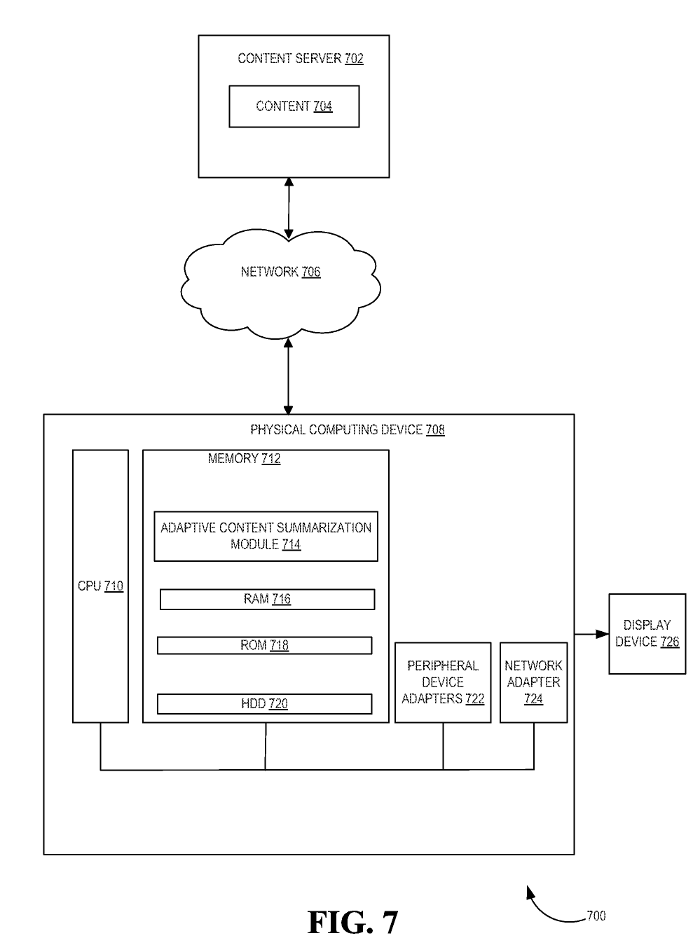

FIG. 7 illustrates an example of a suitable computing system environment for implementing embodiments of the present subject matter, according to one embodiment. Referring now to FIG. 7, an illustrative system (700) for adaptive content summarization includes a physical computing device (708) that has access to content (704) stored by a content server (702). In the present example, for the purposes of simplicity in illustration, the physical computing device (708) and the content server (702) are separate computing devices communicatively coupled to each other through a mutual connection to a network (706). However, the principles set forth in the present specification extend equally to any alternative configuration in which the physical computing device (708) has complete access to content (704). As such, alternative embodiments within the scope of the principles of the present specification include, but are not limited to, embodiments in which the physical computing device (708) and the content server (702) are implemented by the same computing device, embodiments in which the functionality of the physical computing device (708) is implemented by a multiple interconnected computers (e.g., a server in a data center and a user's client machine), embodiments in which the physical computing device (708) and the content server (702) communicate directly through a bus without intermediary network devices, and embodiments in which the physical computing device (708) has a stored local copy of the content (704) to be summarized.

The physical computing device (708) of the present example is a computing device configured to retrieve the content (704) hosted by the content server (702) and summarize the content (704) based on a size of a display device 726. In the present example, this is accomplished by the physical computing device (708) requesting the content (704) from the content server (702) over the network (706) using the appropriate network protocol (e.g., Internet Protocol (“IP”)). Illustrative processes of summarizing the content will be set forth in more detail below.

To achieve its desired functionality, the physical computing device (708) includes various hardware components. Among these hardware components may be at least one processing unit (710), at least one memory unit (712), peripheral device adapters (722), and a network adapter (724). These hardware components may be interconnected through the use of one or more busses and/or network connections.

The processing unit (710) may include the hardware architecture necessary to retrieve executable code from the memory unit (712) and execute the executable code. The executable code may, when executed by the processing unit (710), cause the processing unit (710) to implement at least the functionality of retrieving the content (704) and summarizing the content (704) according to the methods of the present specification described below. In the course of executing code, the processing unit (710) may receive input from and provide output to one or more of the remaining hardware units.

The memory unit (712) may be configured to digitally store data consumed and produced by the processing unit (710). Further, the memory unit (712) includes an adaptive content summarization module 714. The memory unit (712) may also include various types of memory modules, including volatile and nonvolatile memory. For example, the memory unit (712) of the present example includes Random Access Memory (RAM) 716, Read Only Memory (ROM) 718, and Hard Disk Drive (HDD) memory 720. Many other types of memory are available in the art, and the present specification contemplates the use of any type(s) of memory in the memory unit (712) as may suit a particular application of the principles described herein. In certain examples, different types of memory in the memory unit (712) may be used for different data storage needs. For example, in certain embodiments the processing unit (710) may boot from ROM, maintain nonvolatile storage in the HDD memory, and execute program code stored in RAM.

The hardware adapters (722, 724) in the physical computing device (708) are configured to enable the processing unit (710) to interface with various other hardware elements, external and internal to the physical computing device (708). For example, peripheral device adapters (722) may provide an interface to input/output devices to create a user interface and/or access external sources of memory storage. Peripheral device adapters (722) may also create an interface between the processing unit (710) and the display device (726) or other media output device.

A network adapter (724) may provide an interface to the network (706), thereby enabling the transmission of data to and receipt of data from other devices on the network (706), including the content server (702).

The above described embodiments with respect to FIG. 7 are intended to provide a brief, general description of the suitable computing environment 700 in which certain embodiments of the inventive concepts contained herein may be implemented.

In one embodiment, the adaptive content summarization module 714 is configured to compute a summary size of content based on a UCF and an ILF, extract a summary of the content based on the summary size, and display the extracted summary on a display device. The adaptive content summarization module 714 is further configured to allow a user to adapt the summary size of the displayed summary using gestural actions, extract summary corresponding to the adapted summary size based on ranking of each component, and display the extracted summary corresponding to the adapted summary size on the display device.

For example, the adaptive content summarization module 714 described above may be in the form of instructions stored on a non transitory computer readable storage medium. An article includes the non transitory computer readable storage medium having the instructions that, when executed by the physical computing device 708, causes the computing device 708 to perform the one or more methods described in FIGS. 1-7.

In various embodiments, the methods and systems described in FIGS. 1 through 7 may enable to determine optimal summary size for a particular consumption medium without user intervention (i.e., the user need not input the summary size). Further, the summary is first presented to the user based on the user's profile, interests, current attention span, device display size etc. Hence the summary adapts itself to various devices and consumption modes (e.g., stationary, mobile etc.) the user may encounter.

Furthermore, the above described methods and systems may enable a user to incrementally adapt (if desired) the presented summary size based on the user's interest. In these embodiments, the summary adaptation can be done using simple hand gestures. Since the ranking of the content components (e.g., sentences for text summarization) are precomputed, the summary adaptation can be done in real time by adding or removing the components (i.e., sentences). Also, since the ontology such as Wikipedia is used to rank the sentences, the ranking automatically reflects current world knowledge. For example, if a new concept or topic emerges, the above described methods and systems for summarization automatically use the new concept. Furthermore, this summarization algorithm is language independent.

Furthermore, the ranking for the content components can be computed offline (e.g. on a server) and embedded along with the content itself (e.g., as metadata in PDF) and then regenerated on the client side for adaptive summarization. In addition, the above described methods and systems reduce the cognitive load on the user and also help in better content consumption. For example, the above described methods and systems process the text document en-route to a mobile device and sends only the summary to the mobile device.

Further, the methods and systems for adaptive content summarization described in FIGS. 1 through 7 can be applied as follows:
1. Adaptive summarization can help cope with the information overload on the WWW, for example, for any large scale information management in large enterprises, or analytics, for instance.
2. It is well acknowledged that mobile phones will be the onramp to the Internet for a large fraction of the world's population. Internet access on the move often happens in attention deficit situation, and the user is capable of assimilating lower amount of information in a mobile context. Adding to this is the limited bandwidth and screen space of the mobile. Hence, the user interaction has to be adapted to the mobile scenario by presenting only the most relevant information to the user based on the user's current interests, attention span and display size.
3. There are several other scenarios where summarization can enable faster and more efficient content consumption. One key use case is around video/audio summarization based on their text description and transcripts.

Furthermore, the methods and systems described in FIGS. 1 through 7 can be extended as follows:
4. Multiple inputs such as multiple web pages, multiple PDF documents, multiple video or audios. This can be achieved by a two step procedure: first, derive individual summaries for each single input as described above; then, combine the individual summaries and run the single input summarizer (i.e., the above described systems and methods for adaptive content summarization) again on the combined summaries to derive a final summary. Depending on the content type, the final summary extraction might have to re-rank content components to prevent extraction of similar components for the summary. For example, any suitable re-ranking procedure can be used for re-ranking the content components.
5. Other media types like video, audio etc. During summary extraction for the video or audio, the content components could be text descriptions corresponding to key frames or virtual video segments or any other suitable components. A similar component to concept mapping could be derived for the video or audio components.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

### APPENDIX A

In order to formally define information loss, we first introduce some notation (Most of the notation and formalism is only for the sake of completeness).
Given a document D of N sentences S₁, S₂, . . . , S_{N}, let C₁, C₂, . . . , C_{M} denote the M concepts conveyed by these N sentences together. Typically, each sentence relates to several concepts, and M>N.
Let G denote the MXN binary connection matrix showing the sentence-to-concept mapping. Define G(m,n)=1 if the n^{th} sentence relates to m^{th} concept, and G(m,n)=0 otherwise. One method of determining this sentence-to-concept mapping is described in FIG. 4. For example, from FIG. 4, we have M=4, N=3, and

$$G = [ \begin{matrix}100 \\ 010 \\ 110 \\ 001\end{matrix} ]$$

Let M(Sₙ)={Cₘ: G(m,n)=1} denote the set of all concepts mapped to sentence Sₙ, and let N(Cₘ)={Sₙ: G(m,n)=1} denote the set of all sentences mapped to concept Cₘ. For convenience, M(Sₙ) and N(Cₘ) can be viewed as vectors as follows

M(Sₙ)=(C₁(Sₙ)C₂(Sₙ) . . . C_{|M(S}_{ₙ}_{)|}(Sₙ))N(Cₘ)=(S₁(Cₘ)S₂(Cₘ) . . . S_{|N(C}_{ₘ}_{)|}(Cₘ)) (A.1)
Let S(p;D)=(S₁(p) S₂(p) S_{└Np┘}(p)) denote the document summary for summary size parameter p, where Sᵢ(p) denotes a sentence chosen from the original document D by any ‘good’ summarization algorithm S. Thus, S(p;D) can be viewed as a vector of sentences that are chosen to represent the document summary.
Define the corresponding vector of summary concepts as

C(p)=(M(S₁(p))M(S₂(p)) . . . M(S_{└Np┘}(p))), (A.2)

where M(Sᵢ(p)) is the vector of concepts mapped to sentence Sᵢ(p), as defined in (3).
For Comparison, Let Us Also Define the Vector of Concepts for the Entire Document D as

C=(M(S₁)M(S₂) . . . M(S_{N})). (A.3)

For example, for FIG. 5, suppose S(p)=(S₁ S₂), then C(p)=(M(S₁) M(S₂))=(C₁ C₃ C₂ C₃), and C=(M(S₁) M(S₂) M(S₃))=(C₁ C₃ C₂ C₃C₄).
With these preliminaries, we are now ready to formally define ‘information loss’. In words, it is defined as the normalized conditional concept entropy (CCE) of C given C(p), denoted as NCCE(C/C(p)).

Mathematically, we denote information

$$loss ≡ NCCE ( C / C ( p ) ) = \frac{CCE ( C / C ( p ) )}{CCE ( C / C ( 0 ) )} ,$$

where

$$C C E ( C / C ( p ) ) = {\sum }_{k = 1}^{M} ( {e}^{- λ {v}_{k} ( p )} ) ( {e}^{- η ( {v}_{max} - {v}_{k} )} ) ( \frac{{v}_{k} - {v}_{k} ( p )}{{\sum }_{k = 1}^{M} {v}_{k}} ) log ( \frac{{\sum }_{k = 1}^{M} {v}_{k}}{{v}_{k}} ) \qquad ( A .4 )$$

where vₖ denotes the number of occurrences of concept Cₖ in C, vₖ(p) denotes the number of occurrences of concept Cₖ in C(p),

$${v}_{max} = {max}_{k} \{ {v}_{k} \} ,$$

λ and η are tunable parameters, and log(.) represents the natural logarithm unless otherwise mentioned.
In simpler terms, (A.4) measures the “entropy” of additional concepts/topics conveyed by the entire document D, as opposed to those conveyed by the document summary. This is a unique summarization-notion of “entropy”, quite different from current entropy measures like conditional entropy, f-information, generalized entropy and divergence measures—none of which are directly applicable in the context of content summarization for the following reasons.
A low-frequency concept constitutes an inadequate explanation of a new topic, and thus must represent negligible information loss (if this low-frequency concept is left out of the summary). Similarly, a high-frequency concept should incur a high information loss if it is left out of the summary. However, the self-information of a low-frequency concept is relatively high, and that of a high-frequency concept can be relatively low. Therefore, we introduce an exponential weighting factor in (A.4), namely e^{-η(v}^{ₘₐₓ}^{-v}^{ₖ₎}, which further modulates the self-information. The parameter η can be tuned to control the rate of this modulation. We set

$$η = \frac{log ( 1 / ɛ )}{{v}_{max} - {v}_{min}}$$

with ε=0.01, so that the weighting factor exponentially decreases from 1 when vₖ=vₘₐₓ down to ε=0.01 when vₖ=vₘᵢₙ.
If a concept has high frequency of occurrence (i.e., it is an important concept conveyed by the document), then its successive repetitions in the summary offer progressively lesser and lesser information to the user. This is akin to a law of diminishing returns, whereby the user successively gains very little by a repeated thrusting of similar information. This characteristic is reflected in the exponential weighting factor e^{-λv}^{ₖ}^{(p)}, where the parameter λ controls the rate of diminishing returns. We set λ=log 2 which has the effect of halving the information loss for each successive occurrence of the concept in the summary. Again, this behavior is unique to summaries, and is not captured by any of the classical entropy measures.

What is claimed is:

1. A method of adaptive content summarization, comprising:
computing a summary size of content based on a usability cost function (UCF) and an information loss function (ILF);
extracting a summary of the content based on the summary size; and
displaying the extracted summary on a display device.

2. The method of claim 1, wherein the UCF is derived based on parameters selected from group consisting of consumption medium parameters, user-specific parameters, and content-specific parameters.

3. The method of claim 2, wherein the consumption medium parameters comprise parameters selected from the group consisting of a screen size of the display device and power of the display device, wherein the user-specific parameters comprise parameters selected from the group consisting of a user profile, time available to a user and user attention, and wherein the content-specific parameters comprise text content selected from the group consisting of web pages and text documents.

4. The method of claim 2, wherein the content-specific parameters comprise parameters selected from the group consisting of video content and audio content for which a text representation can be derived.

5. The method of claim 1, wherein the UCF can be derived using the following expression:
$$\frac{tanh ( β ( p - α ) ) - tanh ( - βα )}{tanh ( β ( 1 - α ) ) - tanh ( - βα )}$$
wherein, p represents a summary size parameter having a range of 0 to 1, α and β are tunable parameters, tan h(β(p-α)) is a scaled and shifted tan h function, and the terms tan h(β(1-α)) and tan h(−βα) are used to normalize usability cost to lie in the range of 0 to 1.

6. The method of claim 1, wherein the ILF measures loss of information in consuming the summary when compared with the entire content, and wherein the ILF is derived based on parameters selected from group consisting of user-specific parameters and content-specific parameters.

7. The method of claim 6, wherein the user-specific parameters comprise parameters selected from the group consisting of a user profile and query-based parameters, and wherein the content-specific parameters comprise parameters selected from the group consisting of text content and video content and audio content for which a text representation can be derived.

8. The method of claim 1, wherein extracting the summary of the content based on the summary size, comprises:
mapping each component to one or more concepts obtained using an ontological analysis, wherein each component comprises at least one of a paragraph, a sentence, a phrase and a clause;
ranking each component based on the mapping;
selecting components for the summary based on the ranking of each component and the summary size; and
extracting the summary of the content based on the selected components.

9. The method of claim 8, further comprising:
allowing a user to adapt the summary size of the displayed summary using gestural actions;
extracting a summary corresponding to the adapted summary size based on the ranking of each component; and
displaying the extracted summary corresponding to the adapted summary size on the display device.

10. The method of claim 8, wherein mapping each component to the one or more concepts is language independent, and wherein the ontological analysis comprises analysis using ontologies.

11. The method of claim 1, wherein the display device comprises a device selected from the group consisting of a mobile phone, a netbook computer, a notebook computer, a wide screen computer, a slate computer and a television, and wherein the summary size comprises a percentage of the content for displaying as the summary on the display device.

12. A system for adaptive content summarization, comprising:
a processor; and
memory operatively coupled to the processor, wherein the memory includes an adaptive content summarization module having instructions capable of:
computing a summary size of content based on a usability cost function (UCF) and an information loss function (ILF);
extracting a summary of the content based on the summary size; and
displaying the extracted summary on a display device.

13. The system of claim 12, wherein extracting the summary of the content based on the summary size, comprises:
mapping each component to one or more concepts obtained using an ontological analysis, wherein each component comprises at least one of a paragraph, a sentence, a phrase and a clause;
ranking each component based on the mapping;
selecting components for the summary based on the ranking of each component and the summary size; and
extracting the summary of the content based on the selected components.

14. The system of claim 13, wherein the adaptive content summarization module further capable of:
allowing a user to adapt the summary size of the displayed summary using gestural actions;
extracting a summary corresponding to the adapted summary size based on the ranking of each component; and
displaying the extracted summary corresponding to the adapted summary size on the display device.

15. A non transitory computer readable storage medium for adaptive content summarization having instructions that, when executed by a computing device, cause the computing device to perform a method comprising:
computing a summary size of content based on a usability cost function (UCF) and an information loss function (ILF);
extracting a summary of the content based on the summary size; and
displaying the extracted summary on a display device.
